(19) United States
(12) Patent Application Publication
(10) Pub. No.: US 2026/0257132 A1
(43) Pub. Date: Sep. 3, 2026

(54) CONTENT PROCESSING DEVICE AND CONTENT PROCESSING METHOD

(71) Applicants: Sony Interactive Entertainment Inc., Tokyo (JP); Sony Interactive Enterainment LLC, San Mateo, CA (US)

(72) Inventors: Xinyu Zhang, Tokyo (JP); Norihide Kaneko, Tokyo (JP); Kazuyuki Arimatsu, Tokyo (JP); Takayuki Shinohara, Tokyo (JP); Hao Fang, Tokyo (JP); Elaine Wu, San Francisco, CA (US)

(73) Assignees: Sony Interactive Entertainment Inc., Tokyo (JP); Sony Interactive Entertainment LLC., San Mateo, CA (US)

(21) Appl. No.: 19/662,294

(22) Filed: Apr. 29, 2026

Related U.S. Application Data
(63) Continuation of application No. PCT/JP2024/032292, filed on Sep. 10, 2024.
(60) Provisional application No. 63/546,544, filed on Oct. 31, 2023.

(51) Int. Cl. A63F 13/5252; G06T 17/20; G06V 10/82

(52) U.S. Cl. CPC A63F 13/5252; G06T 17/20; G06V 10/82; A63F 2300/638

(57) ABSTRACT

In a game play phase 210, a content server determines, as a timing for presenting a trophy, a time at which the status of the display world corresponding to the user operations has met a predetermined condition (S10). The content server collects training images indicating the scene being displayed at this point (S12), and generates 3D scene information 220 through machine learning (S14). In a trophy appreciation phase 212, in response to a request from the user, the content server generates and outputs a display image representing the trophy viewed from a given viewpoint, using the 3D scene information 220 (S16). The content server also receives an order placed for fabrication of a physical object corresponding to the trophy (S18).

### TECHNICAL FIELD

The present invention relates to a content processing apparatus and a content processing method for processing content such as electronic games.

### BACKGROUND ART

The expansion of communication networks and the development of an image processing technology in recent years have enabled people to enjoy diverse electronic content regardless of their audiovisual environment. In the field of electronic games, for example, systems are prevalent where a server collects information regarding a status of individual client terminals such as details of user operations and locations of users and causes the collected information to be reflected as needed in the image data to be distributed, thereby allowing a plurality of players to participate in the same game regardless of their locations.

Meanwhile, progress in a machine learning technology such as deep learning has provided easy access to technologies for acquiring diverse information from images. For example, there is a technology called NeRF (Neural Radiance Fields), a method of the expression of a 3D (three-dimensional) space using a neural network. The NeRF provides a method of expressing the volume density and radiance of an object in the 3D space in terms of a 5D (five-dimensional) function consisting of position coordinates and directions through the use of a neural network. For example, images of an object taken from a plurality of directions may be used as the basis for acquiring an NeRF expression. This makes it possible to express the object by volume rendering as seen from any viewpoint (e.g., see NPL 1).

### CITATION LIST

### Non Patent Literature

### [NPL 1]

Ben Mildenhall and five others, “NeRF: Representing Scenes as Neural Radiance Fields for View Synthesis,” Communications of the ACM, January 2022, Vol. 65, No. 1, p. 99-106

### SUMMARY

### Technical Problem

Image processing based on the above-mentioned machine learning permits acquisition of images with high degree of freedom from limited information. On the other hand, one problem with such image processing is that appropriate and sufficient amounts of images are required for training, which limits the scope of applications. For example, in the case of content in which the scene targeted for display is changed in real time in response to user operations, there is the problem of when to acquire training images from the constantly changing scene and how to use the acquired information, which hampers incentives to adopt such image processing.

The present invention has been made in view of the above circumstances. An object of the invention is therefore to implement a new function by easily applying machine learning to the content of which the display world is changed in status in response to user operations.

### Solution to Problem

In solving the above problem and according to one embodiment of the present invention, there is provided a content processing apparatus. This content processing apparatus includes a main image generating section configured to generate, at a predetermined rate, a frame of a main image indicating what a three-dimensional display world looks like from a display viewpoint, the three-dimensional display world being changed in status in response to a user operation on currently executed content, a trophy presentation determining section configured to determine, as a timing for presenting a trophy, a time at which the status of the display world has met a predetermined condition as a result of the user operation, a three-dimensional scene information generating section configured to assume, as the trophy, at least a portion of a currently displayed scene at the timing of the trophy presentation, before generating three-dimensional scene information representing three-dimensional information regarding the scene through machine learning using, as training data, the main image indicating what the trophy looks like from a plurality of viewpoints, and a three-dimensional scene information storing section configured to store the three-dimensional scene information in association with a user performing the user operation.

According to another embodiment of the present invention, there is provided a content processing method. This content processing method includes the steps of generating, at a predetermined rate, a frame of a main image indicating what a three-dimensional display world looks like from a display viewpoint, the three-dimensional display world being changed in status in response to a user operation on currently executed content, determining, as a timing for presenting a trophy, a time at which the status of the display world has met a predetermined condition as a result of the user operation, assuming, as the trophy, at least a portion of a currently displayed scene at the timing of the trophy presentation, before generating three-dimensional scene information representing three-dimensional information regarding the scene through machine learning using, as training data, the main image indicating what the trophy looks like from a plurality of viewpoints, and storing the three-dimensional scene information in a storage apparatus, in association with a user performing the user operation.

It is to be noted that suitable combinations of the above constituent elements and the expressions of the present invention, when converted between a method, an apparatus, a system, a computer program, a data structure, and a recording medium, among others, are also effective as embodiments of the present invention.

### Advantageous Effects of Invention

The present invention implements a new function by easily applying machine learning to the content of which the display world can be changed in status in response to user operations.

### BRIEF DESCRIPTION OF DRAWINGS

FIG. 1 is a diagram depicting an exemplary configuration of a content processing system to which the present embodiment may be applied.

FIG. 2 is a diagram schematically depicting the relation between a display world and a display image in an electronic game assumed to be the target for processing by the present embodiment.

FIG. 3 is a diagram schematically depicting a flow of processing of the present embodiment.

FIG. 4 is a diagram depicting an internal circuit configuration of a client terminal of the present embodiment.

FIG. 5 is a diagram depicting functional block configurations of a client terminal and a content server of the present embodiment.

FIG. 6 is a diagram schematically depicting a sequence of images generated in a game play phase of the present embodiment.

FIG. 7 is a diagram schematically depicting an exemplary image displayed when the presentation of a trophy is determined by the present embodiment.

FIG. 8 is a diagram schematically depicting an exemplary flow of processes taking place following the presentation of the trophy by the present embodiment.

### DESCRIPTION OF EMBODIMENT

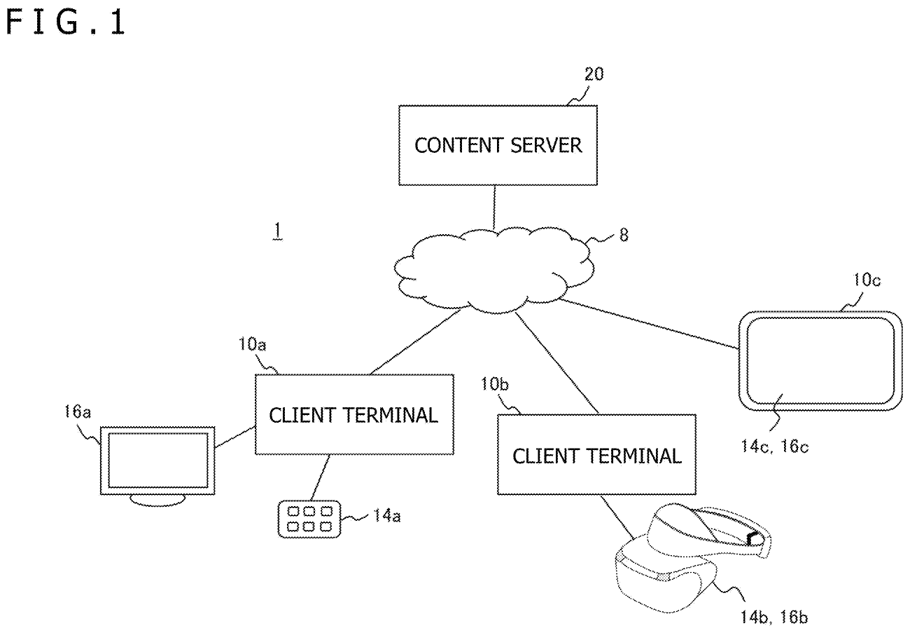

FIG. 1 depicts an exemplary configuration of a content processing system to which the present embodiment may be applied. A content processing system 1 includes client terminals 10a, 10b, and 10c displaying images such as those of electronic games in response to user operations, and a content server 20 providing image data for display use. The client terminals 10a, 10b, and 10c are connected, respectively, with input apparatuses 14a, 14b, and 14c for user operations and with display apparatuses 16a, 16b, and 16c for image display. The client terminals 10a, 10b, and 10c and the content server 20 may communicate with one another via a network 8 such as a WAN (World Area Network) or a LAN (Local Area Network).

The client terminals 10a, 10b, and 10c; the display apparatuses 16a, 16b, and 16c; and the input apparatuses 14a, 14b, and 14c may be connected with each other, respectively, in a wired or wireless manner. Alternatively, two or more of these apparatuses may be integrally formed. For example, in FIG. 1, the client terminal 10b is connected with a head-mounted display that is the display apparatus 16b. The head-mounted display can also function as the input apparatus 14b because the motion of the user wearing the head-mounted display can change the visual field of display images.

Also, the client terminal 10c may be a mobile terminal or a tablet terminal, for example. The client terminal 10c is formed integrally with the display apparatus 16c and with the input apparatus 14c acting as a touch pad covering the screen of the display apparatus 16c. In this manner, the apparatuses in FIG. 1 are not limited in terms of an external shape or a connection topology. Also, the client terminals 10a, 10b, and 10c and the content server 20 connected to the network 8 are not limited in number. In the description that follows, the client terminals 10a, 10b, and 10c will be generically referred to as the client terminal 10; the input apparatuses 14a, 14b, and 14c as the input apparatus 14; and the display apparatuses 16a, 16b, and 16c as the display apparatus 16.

The input apparatus 14 is a common input apparatus such as a controller, a keyboard, a mouse, a touch pad, and/or a joystick. The input apparatus 14 receives user operations and supplies the client terminal 10 therewith. Alternatively, the input apparatus 14 may be formed of various sensors such as motion sensors and cameras attached to the head-mounted display, the mobile terminal, or the tablet terminal. Sensor data from these sensors may be supplied to the client terminal 10. The display apparatus 16 may be a common display such as a liquid crystal display, a plasma display, an organic EL (electroluminescence) display, a wearable display, or a projector. The display apparatus 16 displays images output from the client terminals 10.

The content server 20 provides the client terminal 10 with the data of content involving image display. In the present embodiment, the content server 20 basically generates video and audio data of content, and transmits instantaneously the generated data to the client terminal 10 to implement streaming.

At this point, the content server 20 may consecutively acquire from the client terminal 10 the information regarding operations performed by a user on the input apparatus 14 or the sensor data obtained by the diverse sensors, and cause the acquired information and data to be reflected in images and sounds. This makes it possible for a plurality of users to participate in the same game or communicate with each other in a virtual world. It is to be noted, however, that the configuration of the image display system is not limited to what is illustrated in FIG. 1. For example, the entity that generates images is not limited to the content server 20, and the images may be generated alternatively by the client terminal 10 itself or by both the client terminal 10 and the content server 20 in cooperation.

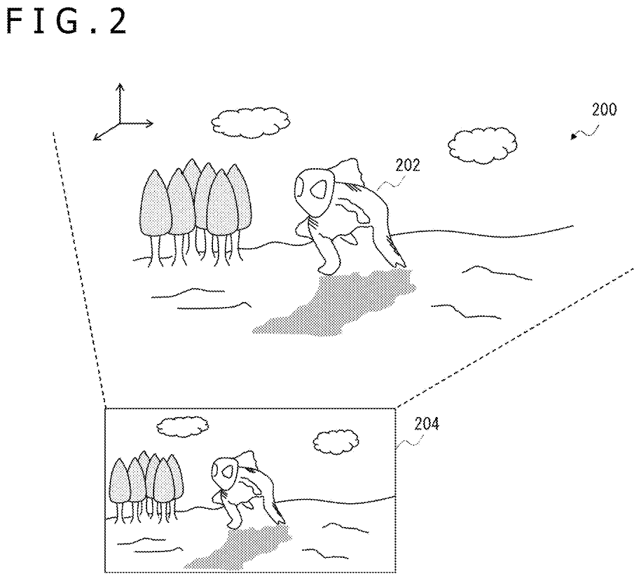

FIG. 2 is a diagram schematically depicting the relation between a display world and a display image in an electronic game assumed to be the target for processing by the present embodiment. As mentioned above, the principal processing may be performed by either the content server 20 or the client terminal 10 or by both in cooperation. It is thus assumed, for explanatory purposes, that the processing is carried out not by any particular entity but by what may be called a “content processing apparatus.” For this embodiment, for example, electronic games are assumed to be played by users for collective adventures or for competitions in a virtual world prescribed in a 3D space.

In the example in FIG. 2, a display world 200 is assumed to be a virtual 3D space where there is an enemy character 202, among others. By carrying out operations on the input apparatus 14, a user can move in the display world and fight against the enemy character 202, for example. In response to the user operations, the content processing apparatus changes the display world as needed, generates a display image 204 at a predetermined rate, and outputs the generated image to the display apparatus 16. At this point, the content processing apparatus acquires the position of the viewpoint from which the user can perform operations as well as the direction of the user's visual line, and determines the visual field of the display image 204 according to what is thus acquired. In the description that follows, the state of an object found in the visual field of the display image 204 will be referred to as a “scene.” In some cases, the position of the viewpoint and the direction of the visual line relative to the scene may simply be referred to as a “viewpoint.”

In the case of a multi-player game, the content processing apparatus parallelly acquires details of user operations from a plurality of users and causes what is acquired to be reflected in the display world 200. Whereas the display image 204 in FIG. 2 is what is called a first-person view image as seen from the character operated by the user, this is not limitative of the present embodiment. For example, there may be what is called a third-person view image that includes in its viewing angle the character operated by the user. This embodiment generates through machine learning 3D scene information representing a currently displayed scene at a timing at which the status of the game and that of the display world have met predetermined conditions, such as at the timing at which the user has made a major achievement in the electronic game.

By storing the 3D scene information for commemorative use, the user is able to view, at any later timing from various directions, the scene capturing the moment of the achievement in the game. The 3D scene information may also be used to turn the scene into a physical object using a 3D printer, for example. In the description that follows, the object regarding which the 3D information is generated will be referred to as a “trophy,” and the act of generating and storing the 3D scene information in association with the user will be referred to as “trophy presentation.” The timing for presenting the trophy is prescribed in the game program. For example, when a predetermined number of enemies have been defeated in the display world, when the lap time in a car race has turned out to be within a predetermined time, or when predetermined stages have been cleared, for example, the content processing apparatus presents the trophy to the user at the scene where a sense of achievement is experienced by the user.

In order to generate the 3D scene information regarding the scene displayed at the time when the trophy presentation is determined, the content processing apparatus collects training images indicating how the scene looks like from various directions. In the case where NeRF is applied to machine learning, the content processing apparatus first inputs viewpoint information defined upon generation of each of the training images, i.e., the position of a virtual viewpoint and the direction of a virtual visual line of each image, and acquires the data representing the 3D information regarding the scene by regression using a multilayer perceptron (MLP) with the corresponding training images taken as training data. The data constitutes a neural network that inputs 5D parameters consisting of position coordinates (x, y, z) and a direction vector d (θ,φ) in a 3D space and outputs a volume density a and primary-color information c (RGB).

In this embodiment, the data of the neural network is referred to as “3D scene information.” It is to be noted, however, that any technology other than NeRF for estimating 3D information from a plurality of two-dimensional images may be adopted and that the representational form of the 3D scene information is not limited to anything specific. To obtain the 3D scene information with high accuracy, it is preferred that images of the scene as viewed from as many viewpoints as possible be collected as the training images. In view of this, once the trophy presentation is determined, the content processing apparatus establishes a plurality of viewpoints for generating the training images of the scene for intensive generation of images from diverse viewpoints.

By separately generating display images using the stored 3D scene information, the content processing apparatus allows the user to view the trophy from any desired direction. Use of the 3D scene information permits high-quality representation of how the scene looks like from any viewpoint at a relatively low load. In the case where NeRF is applied, the content processing apparatus causes a ray r to be generated to pass through a pixel of a view screen from a display viewpoint and, by volume rendering integrating colors in the ray direction, obtains a pixel value C(r) of the display image as follows.

### BRIEF DESCRIPTION OF THE DRAWINGS

$$C ( r ) = {\int }_{{t}_{n}}^{{t}_{f}} T ( t ) σ ( r ( t ) ) c ( r ( t ) , d ) dt \qquad [ Math . 1 ]$$

### DETAILED DESCRIPTION OF THE INVENTION

In the above formula, tn stands for the proximal of the ray r, tf for the distal of the ray r, and T(t) for the cumulative transmittance in the ray direction. The cumulative transmittance is expressed as follows.

$$T ( t ) = exp ( - {\int }_{{t}_{n}}^{t} σ ( r ( s ) ) d s ) \qquad [ Math . 2 ]$$

With respect to NeRF, various improved techniques have been proposed in addition to the basic technique disclosed in NPL 1, for example. Any of these techniques may be adopted for this embodiment, and their detailed explanations will not be repeated. The stored 3D scene information provides information regarding the shape, position, and posture of the object at the target scene. In view of this, the content processing apparatus may offer an interface for a service that fabricates a physical object corresponding to the object by using the stored 3D scene information.

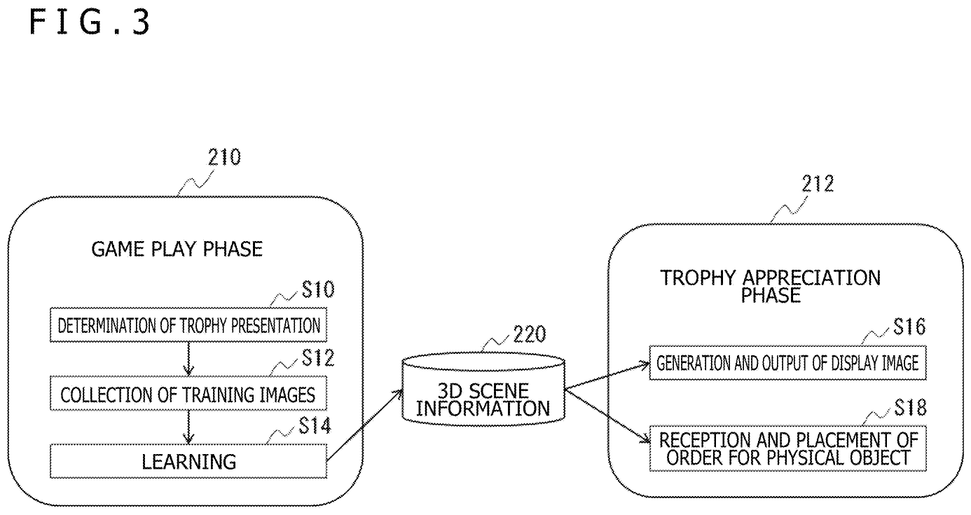

FIG. 3 schematically depicts a flow of processing of the present embodiment. The present embodiment is implemented separately in two periods: in a game play phase 210 and in a trophy appreciation phase 212. The game play phase 210 is the period in which the user plays the game. During this period, the content processing apparatus such as the content server 20 determines the timing of the trophy presentation in accordance with the details of the play (S10).

In turn, the content server 20 assumes the scene being displayed or the object included therein as the trophy, and collects the training images indicating the trophy from a plurality of viewpoints (S12). The content server 20 then generates the 3D scene information representing the trophy through machine learning using the training images as the training data (S14). The trophy appreciation phase 212 is started when the user requests visual appreciation of the trophy at a desired timing such as when game play is interrupted or terminated. During this period, the content processing apparatus such as the content server 20 generates an image of the trophy using the stored 3D scene information 220, and outputs the trophy image for display (S16).

Alternatively, the content server 20 receives from the user an order placed for fabrication of a physical object corresponding to the presented trophy (S18). For example, the content server 20 displays an order screen for ordering the physical object together with the image of the trophy displayed in S16. In the case where the user places the order for the physical object, the content server 20 receives the order, converts the 3D scene information 220 regarding the trophy into mesh data, and places an order as needed for fabrication of the physical object using a 3D printer, for example. In due course, the physical object corresponding to the presented trophy is sent to the user at a later date.

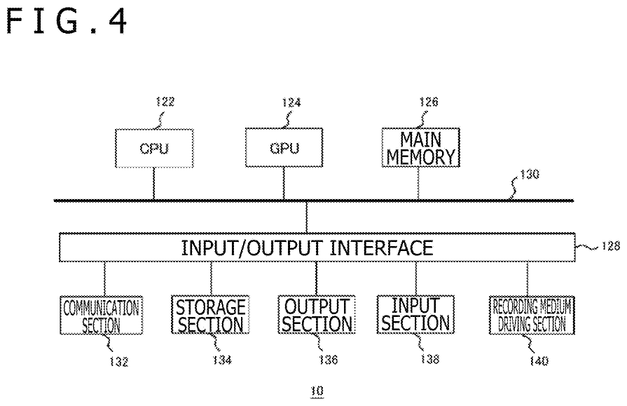

FIG. 4 depicts an internal circuit configuration of the client terminal 10. The client terminal 10 includes a CPU (Central Processing Unit) 122, a GPU (Graphics Processing Unit) 124, and a main memory 126. These components are interconnected via a bus 130. The bus 130 is further connected with an input/output interface 128. The input/output interface 128 is connected with a peripheral interface such as a USB (Universal Serial Bus), a communication section 132 including a network interface for a wired or wireless LAN, a storage section 134 such as a hard disk drive or a nonvolatile memory, an output section 136 that outputs data to the display apparatus 16, an input section 138 that receives input of data from the input apparatus 14, and a recording medium driving section 140 that drives removable recording media such as magnetic disks, optical disks, or semiconductor memories.

The CPU 122 controls the client terminal 10 in entirety by carrying out the operating system stored in the storage section 134. The CPU 122 also executes various programs read from the removable recording media and loaded into the main memory 126 or programs downloaded via the communication section 132. The GPU 124 has the functions of both a geometry engine and a rendering processor. Under rendering instructions from the CPU 122, the GPU 124 performs rendering processing and stores the resulting display image into a frame buffer, not depicted. The GPU 124 then converts the display image stored in the frame buffer into a video signal for output to the output section 136. The main memory 126 includes a RAM (Random Access Memory) and stores programs and data necessary for processing. The content server 20 may also have a similar internal circuit configuration.

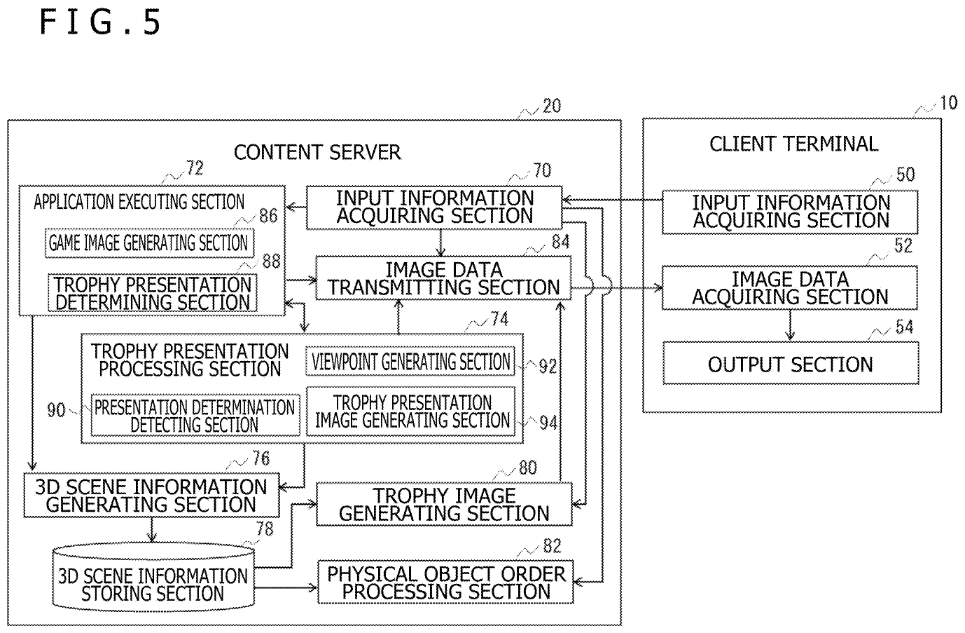

FIG. 5 depicts functional block configurations of the client terminal 10 and the content server 20 of the present embodiment. The functional blocks depicted in FIG. 5 may be configured by hardware using the CPU, GPU, and various memories, or by software using programs typically loaded from recording media into a memory to implement such functions as data input, data retention, image processing, and communication. It will thus be appreciated by those skilled in the art that these functional blocks are configured by hardware only, by software only, or by a combination thereof in diverse forms and are not limited to any one of such forms. Whereas the content server 20 in FIG. 5 plays the principal role of image processing, at least part of the processing may be taken over by the client terminal 10.

The client terminal 10 includes an input information acquiring section 50 that acquires input information such as user operations, an image data acquiring section 52 that acquires image data from the content server 20, and an output section 54 that outputs display image data. The input information acquiring section 50 acquires as needed the details of the user operations from the input apparatus 14. The user operations include selection and starting of the game, input of commands to the game being played, and the like. The input information acquiring section 50 also receives operations to visually appreciate the presented trophy or to place an order for the physical object corresponding to the trophy.

Further, the input information acquiring section 50 acquires information regarding display viewpoints as needed or at predetermined time intervals from the input apparatus 14 or from a head-mounted display. There are known techniques for detecting the position and posture of the head of the user wearing the head-mounted display and for obtaining information regarding the display viewpoints based on the position and posture thus detected. These techniques may also be adopted by the present embodiment. Here, the display viewpoints include those for visually appreciating the presented trophy, in addition to the display viewpoints for game images during game play. The input information acquiring section 50 supplies the acquired information to the content server 20 as needed.

The image data acquiring section 52 acquires display image data from the content server 20. Here, the display image data may include the data of game images during game play, data of the image giving notification of the trophy presentation, data of the display image of the presented trophy, and data of the image for receiving the order placed for the physical object corresponding to the trophy. The output section 54 outputs the display images acquired by the image data acquiring section 52 to the display apparatus 16 for display thereon.

The content server 20 includes an input information acquiring section 70 that acquires input information from the client terminal 10, an application executing section 72 that executes game applications, a trophy presentation processing section 74 that performs processes related to the trophy presentation, a 3D scene information generating section 76 that generates the data of the 3D scene information, a 3D scene information storing section 78 that stores the generated data of the 3D scene information, a trophy image generating section 80 that generates the image of the trophy, a physical object order processing section 82 that processes the order placed for the physical object corresponding to the trophy, and an image data transmitting section 84 that transmits the display image data to the client terminal 10.

The input information acquiring section 70 acquires information regarding the details of and the display viewpoints for user operations as needed or at predetermined time intervals from the client terminal 10. The input information acquiring section 70 supplies the acquired information to the application executing section 72. The application executing section 72 processes the game application based on the details of the user operations. The application executing section 72 includes a game image generating section 86 and a trophy presentation determining section 88.

In the game play phase, the game image generating section 86 generates game images in visual fields corresponding to the display viewpoints at a predetermined rate. The trophy presentation determining section 88 determines the trophy presentation as the game progresses. More specifically, the trophy presentation determining section 88 retains predetermined trophy presentation conditions in an internal memory and, by continuously matching the details of the play against the retained presentation conditions, detects the situation that warrants the trophy presentation. Once the trophy presentation is determined, the game image generating section 86 generates as training images the images indicating the scene at the moment as viewed from various viewpoints. At this point, the application executing section 72 may temporarily stop the game.

The trophy presentation processing section 74 performs various processes related to the trophy presentation. Specifically, the trophy presentation processing section 74 includes a presentation determination detecting section 90, a viewpoint generating section 92, and a trophy presentation image generating section 94. The presentation determination detecting section 90 detects that the trophy presentation determining section 88 has determined the trophy presentation. For example, the presentation determination detecting section 90 acquires notification from the trophy presentation determining section 88 indicating that the trophy presentation is determined, or may periodically inquire of the trophy presentation determining section 88 whether or not the trophy presentation is determined.

When determination of the trophy presentation is detected, the viewpoint generating section 92 generates a plurality of viewpoints for acquiring the training images indicating a display world scene targeted for display at that moment. The viewpoint generating section 92 supplies the generated viewpoints to the application executing section 72 in a format similar to that for the display viewpoints at the normal time. This causes the game image generating section 86 to generate images indicating what the scene looks like as viewed from the generated viewpoints, as the training images.

The trophy presentation image generating section 94 generates an image giving notification that the trophy is presented. The image may include an image indicating the scene being displayed at the time when the presentation is determined. At this point, the trophy presentation image generating section 94 may receive, in response to the displayed image, user operations selecting the object representing the trophy or the region related thereto. This makes it possible to fabricate the trophy satisfying the user's preferences by, for example, removing the background and leaving only a specific object. In this case, the trophy presentation image generating section 94 supplies the 3D scene information generating section 76 with information indicating the object or the region designated as the trophy.

The illustrated example assumes that the application executing section 72 basically generates game images on the basis of the viewpoint information supplied from the input information acquiring section 70. In this case, the viewpoint generating section 92 generates and supplies the viewpoint information in the same format as that of the viewpoint information fed from the input information acquiring section 70. This allows the application executing section 72 to generate the training images by normal processing without distinguishing between true display viewpoints on one hand and the viewpoints generated by the viewpoint generating section 92 on the other hand. As a result, the present embodiment can be applied easily to existing content that is incompatible with machine learning.

However, what is described in the foregoing paragraphs is not limitative of the present embodiment. Preferably, the application executing section 72 may include the viewpoint generating section 92 by designating a previously arranged API (Application Programming Interface) having a viewpoint generating function in the application program. Likewise, at least part of the processes performed by the trophy presentation image generating section 94 may be functionally taken over by the application executing section 72 using the API. In the case where the game has been temporarily stopped for the trophy presentation, the application executing section 72 resumes the game at the time when all the training images have been generated. Alternatively, the application executing section 72 may resume the game at the time when the user has closed the image giving notification of the trophy presentation.

The 3D scene information generating section 76 acquires the training images generated by the application executing section 72 in order to generate the 3D scene information regarding the trophy through the above-described machine learning. In the case where the user, given the scene of the trophy presentation, performs operations to select the object constituting the trophy or the region related thereto, the 3D scene information generating section 76 extracts only the selected object or region from the training images for use in machine learning. Alternatively, the 3D scene information generating section 76 may extract the object or the region selected on its own, from the training images in accordance with predetermined criteria.

For example, in the case where a virtual user having defeated the enemy character is presented with the trophy, the 3D scene information generating section 76 may assume the enemy character at the moment of defeat as the trophy and extract the images of the enemy character from the training images using known techniques such as object recognition. In the case of third-person perspective game images, the 3D scene information generating section 76 may assume both the virtual user and the enemy character as the trophy and extract them from the training images. The 3D scene information storing section 78 stores the 3D scene information regarding the trophy generated by the 3D scene information generating section 76. The 3D scene information storing section 78 stores the 3D scene information in association with information identifying the user presented with the trophy and information indicating what the scene looks like. The storage arrangement allows the user requesting the visual appreciation of the trophy to read the relevant 3D scene information from the stored information.

When the user performs operations to request the visual appreciation of the gained trophy in the trophy appreciation phase, the trophy image generating section 80 generates a display image indicating the trophy through the above-described volume rendering using the 3D scene information stored in the 3D scene information storing section 78. At this point, the trophy image generating section 80 acquires the display viewpoints from the input information acquiring section 70 and, according to the acquired viewpoints, generates the display image while changing the viewpoints relative to the trophy. In the game play phase, the image data transmitting section 84 transmits to the client terminal 10 the data of the game images generated by the game image generating section 86 and the data of the image giving notification of the trophy presentation. In the trophy appreciation phase, the image data transmitting section 84 also transmits to the client terminal 10 the data of the trophy image generated by the trophy image generating section 80.

The physical object order processing section 82 receives from the user an order placed for fabrication of the physical object corresponding to the trophy. The physical object order processing section 82 then places a purchase order using the 3D scene information stored in the 3D scene information storing section 78. The order destination may be another server, not depicted, that offers services for producing solid objects from mesh data using a 3D printer, for example. A screen for accepting the order may be added to the display image of the trophy by the trophy image generating section 80, for example.

In response to the order, the physical object order processing section 82 acquires 3D polygon data from the neural network representing the 3D scene information, and converts the acquired data into common mesh data. At this point, the physical object order processing section 82 may use, for example, the initial 3D scene information to generate rays for doing rendering calculations in a manner similar to the generation of display images. By so doing, the physical object order processing section 82 acquires the position coordinates of a point group on the surface of the object. On the basis of the position coordinates of the point group, the physical object order processing section 82 generates the mesh data of the object by a method such as Marching Cubes (e.g., see NPL 1). The physical object order processing section 82 then places an order for the fabrication of the physical object by associating the mesh data of the trophy with the name and address of the user who has placed the order.

Preferably, the physical object order processing section 82 may only convert the 3D scene information regarding the trophy into mesh data and transmit the converted data to the client terminal 10. This allows the user of the client terminal 10 to directly place the order for the physical object corresponding to the trophy or to fabricate, on their own, the physical object using a 3D printer, for example. The mesh data converted from the 3D scene information may also be used to display the trophy image.

In this case, the trophy image generating section 80 reads the 3D scene information from the 3D scene information storing section 78 for conversion into the mesh data for use in generating the display image. Preferably, the trophy image generating section 80 may assume the mesh data as the trophy data and store the data in a storage section, not depicted. Meanwhile, use of the mesh data enables a common viewer to display images from desired viewpoints. The trophy image generating section 80 may thus transmit the mesh data of the trophy to the client terminal 10 for generation of the display image on the side of the client terminal 10. In this manner, the user can also appreciate the gained trophy visually from various viewpoints in an offline environment.

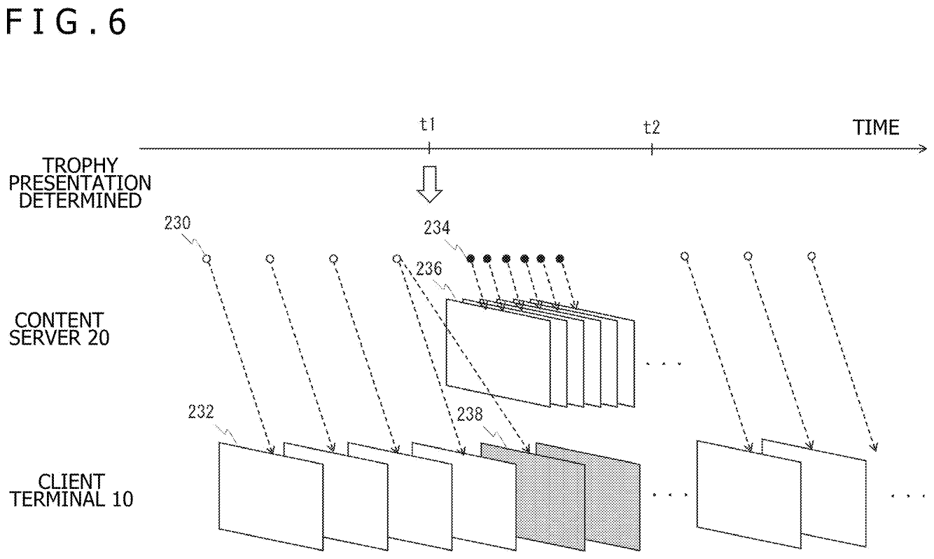

FIG. 6 schematically depicts a sequence of images generated in the game play phase. In FIG. 6, the time axis is taken in a horizontal direction to indicate thereon the relation between the viewpoints recognized or generated by the content server 20 on one hand, and the destinations reached by the frames generated from these viewpoints on the other hand. The content server 20 basically generates display image frames (e.g., frames 232) at a predetermined rate in a manner corresponding to display viewpoints (e.g., display viewpoints 230) each indicated by a small hollow circle, before transmitting the generated frames to the client terminal 10.

In the process, when the trophy presentation is determined at time t1, the trophy presentation processing section 74 starts processes related to the trophy presentation. Specifically, the content server 20 generates viewpoints (e.g., viewpoints 234) each indicated by a small solid circle in the drawing, and generates training images (e.g., training images 236) corresponding to the generated viewpoints. As illustrated, in keeping with the processing capacity of the content server 20, the rate at which the training images are generated may be made higher than that for display.

As an example, if the viewpoint generating section 92 prepares as many as 300 viewpoints that are in turn processed consecutively by the game image generating section 86, then 300 training images can be generated in a few seconds. In the period in which the training images are being generated, the content server 20 temporarily stops the game, generates an image (e.g., shaded image 238) giving notification of the trophy presentation, and transmits the generated image to the client terminal 10. The image giving notification of the trophy presentation is displayed until time t2 at which the content server 20 completes generation of a predetermined number of training images. Based on the training images generated by time t2, the content server 20 generates the 3D scene information regarding the trophy and stores the generated information into the 3D scene information storing section 78. The content server 20 resumes the game at time t2, generates display image frames at a predetermined rate in a manner corresponding to the most recent display viewpoint, and transmits the generated frames to the client terminal 10.

In the illustrated example, the image giving notification of the trophy presentation is displayed in the period in which the training images are being generated. The generated training images are not transmitted to the client terminal 10 but used only for machine learning. Preferably, while the training images are being generated, at least part of the training images may be transmitted to the client terminal 10 for display thereon. The viewpoints for displaying the training images are generated in such a manner that the target scene may be viewed from various directions. Thus, if the viewpoints are generated in an appropriate sequence and if the training images acquired from these viewpoints are used sequentially as the display images, it is possible to display a dynamic moving image indicating the target scene as if it were imaged from a viewpoint circling around the scene. Such an image may also be used as a portion of the image giving notification of the trophy presentation.

The images generated as the game images for display use may be appropriated as training images. In the case of a multi-player game, there may be times at which the same scene is viewed from different viewpoints by different users as players. Thus, the content server 20 may retain the data of the display images transmitted to each client terminal 10 for a predetermined time period and, once the presentation of the trophy to one of the users is determined, may extract the display images indicating the target scene for use in machine learning. That means the images for use as the training mages may be those generated before the time at which the trophy presentation is determined.

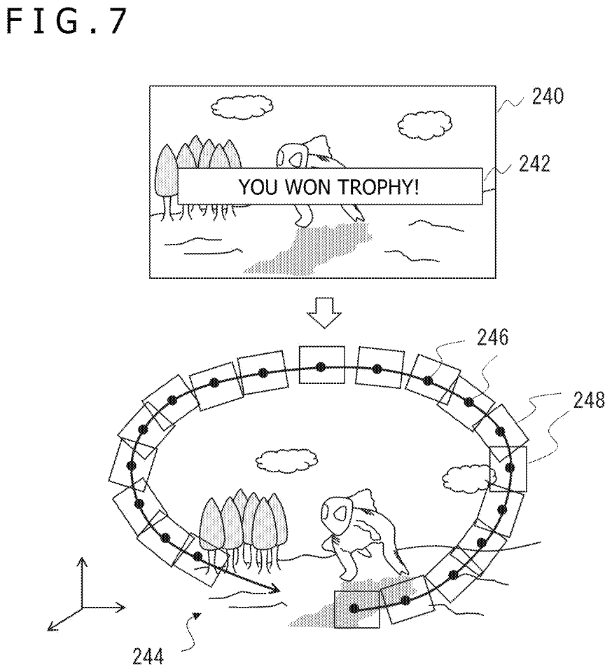

FIG. 7 schematically depicts an exemplary image displayed when the trophy presentation is determined. Immediately after determination of the trophy presentation, the trophy presentation image generating section 94 generates and displays an image 240 giving notification that the trophy presentation is determined. In FIG. 7, the image 240 giving details of the notification is superposed on the game image at that moment. Meanwhile, the game image generating section 86 generates the training images corresponding to the viewpoints generated by the viewpoint generating section 92.

The lower part of FIG. 7 schematically depicts a plurality of viewpoints (e.g., viewpoints 246) set for a scene 244 in a 3D image world, and screen planes (e.g., screen planes 248) of the image set for each of the viewpoints. It is to be noted that, in practice, a larger number of viewpoints may be set and arranged evenly on the surface of a hemisphere centering on the scene, for example, in order to generate the training images from all directions. The game image generating section 86 renders images on the screen planes corresponding to the viewpoints through ray tracing, for example. Given the images thus generated, the image data transmitting section 84 may extract the images from a continuous sequence of viewpoints and transmit the extracted images to the client terminal 10 for consecutive display thereon.

In FIG. 7, the way in which the images seen from the viewpoints in a sequence encircling the scene 244 are extracted is indicated by an arrow connecting these viewpoints. When the images are displayed in the arrowed sequence, the user can visually appreciate special images indicating the target scene from the viewpoints circling around the image world. Preferably, the display of such training images may be implemented in a portion of the image 240 giving notification of the trophy presentation.

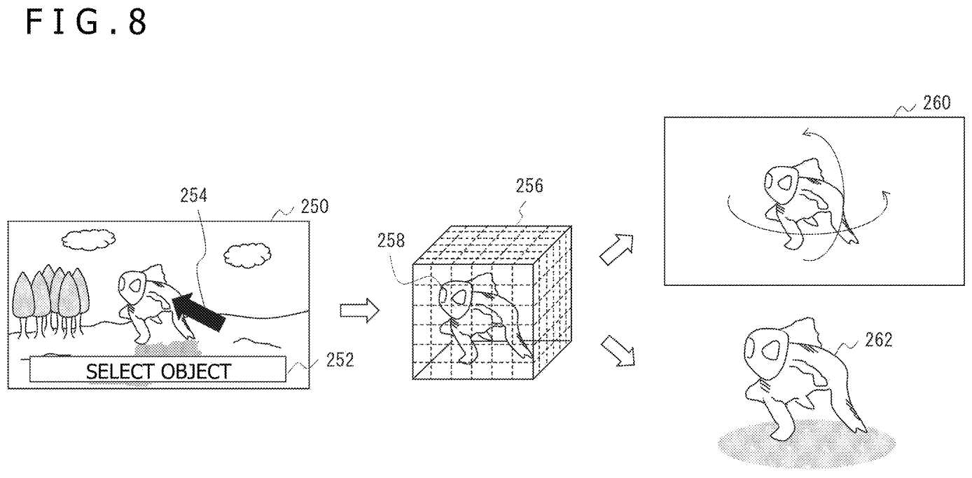

FIG. 8 schematically depicts an exemplary flow of processes taking place following the trophy presentation. At the time when the notification of the trophy presentation is given, for example, the trophy presentation image generating section 94 generates and displays an image 250 for receiving the selection of the target desired for the trophy. In FIG. 8, a message 252 prompting the selection of the object as the target and a cursor 254 as means of selection are superposed on the game image at the moment of the trophy presentation. When the user selects and inputs the desired object, the 3D scene information generating section 76 clips, for training use, the images of the selected object from the training images by known techniques such as object recognition.

In this manner, 3D scene information 256 regarding the selected object 258 is generated and stored into the 3D scene information storing section 78. In practice, the 3D scene information 256 is the neural network data as discussed above. In the trophy appreciation mode, the trophy image generating section 80 generates a display image 260 indicating the trophy in response to a request from the user, and transmits the generated image to the client terminal 10 for display thereon. The user may perform operations to rotate the trophy, for example, as indicated by arrows in FIG. 8 while viewing the display image 260. This enables the user to appreciate visually the trophy from any desired viewpoint.

At this time, the trophy image generating section 80 continuously generates the display image from the display viewpoints corresponding to the user operations. As discussed above, the trophy image generating section 80 may convert the 3D scene information formed by the neural network into mesh data, and generate the display image using the mesh data. Preferably, the image data transmitting section 84 may transmit the mesh data to the client terminal 10. In this case, the client terminal 10 can, on its own, generate and display the display image using a common viewer.

In response to user operations placing an order for the physical object corresponding to the trophy, the physical object order processing section 82 places an order for the fabrication of the physical object. At this point, the physical object order processing section 82 converts the 3D scene information formed by the neural network into mesh data for use as the model data upon placement of the order. This enables the physical object to be fabricated by commonly available means. In due course, a physical object 262 corresponding to the trophy fabricated by a 3D printer, for example, is sent to the user.

In the above-described embodiment, the content server 20 detects the timing defined within the game application, and presents the scene being displayed at that moment as the trophy. At this point, the content server 20 performs machine learning through intensive generation of the training images and thereby generates the 3D scene information representing the scene. This makes it possible for the user to appreciate visually the state of the object found at the very moment when the trophy presentation is determined, at any subsequent timing.

Also, the content server 20 converts the 3D scene information regarding the trophy formed by the neural network into mesh data for use in fabricating the physical object corresponding to the trophy. The content server 20 may preferably transmit the mesh data to the client terminal 10. This enables the user to obtain the physical object corresponding to the trophy fabricated by a 3D printer, for example, or to appreciate visually the image of the trophy offline.

The present invention has been described above in conjunction with a specific embodiment. It is to be understood by those skilled in the art that the present embodiment is merely illustrative in nature, that suitable combinations of the constituent elements and various processes of the present embodiment will lead to further variations of the present invention, and that such variations also fall within the scope of this invention.

### INDUSTRIAL APPLICABILITY

As described above, the present invention is applicable to various types of information processing apparatuses such as a content processing apparatus, a content server, a game apparatus, a mobile terminal, and a personal computer, a content service providing system including any of these apparatuses, and the like.

### REFERENCE SIGNS LIST

1: Image display system
10: Client terminal
14: Input apparatus
16: Display apparatus
20: Content server
50: Input information acquiring section
52: Image data acquiring section
54: Output section
70: Input information acquiring section
72: Application executing section
74: Trophy presentation processing section
76: 3D scene information generating section
78: 3D scene information storing section
80: Trophy image generating section
82: Physical object order processing section
84: Image data transmitting section
86: Game image generating section
88: Trophy presentation determining section
90: Presentation determination detecting section
92: Viewpoint generating section
Trophy presentation image generating section
122: CPU
124: GPU
126: Main memory

1. A content processing apparatus comprising:
a main image generating section for generating, at a predetermined rate, a frame of a main image including a three-dimensional display world from a display viewpoint, the three-dimensional display world being changed in status in response to a user operation on currently executed content;
a trophy presentation determining section for determining, as a timing for presenting a trophy, a time at which the status of the three-dimensional display world has met a predetermined condition as a result of the user operation;
a three-dimensional scene information generating section for assuming, as the trophy, at least a portion of a displayed scene at the timing for presenting the trophy, before generating three-dimensional scene information through machine learning using, as training data, the main image indicating appearances of the trophy from a plurality of viewpoints; and
a three-dimensional scene information storing section for storing the three-dimensional scene information in association with the user operation.

2. The content processing apparatus of claim 1, further comprising:
a viewpoint generating section for generating generate added viewpoints, independent of the display viewpoint, from which to generate images for use in the machine learning, at the timing for presenting the trophy, wherein:
the main image generating section further generates frames of the main image corresponding to the added viewpoints.

3. The content processing apparatus of claim 1, further comprising:
a trophy image generating section for generating a display image of the display scene including a given appearance of the trophy from a given viewpoint, using the three-dimensional scene information.

4. The content processing apparatus of claim 1, further comprising:
an image data transmitting section for converting the three-dimensional scene information into mesh data and transmitting the mesh data to a client terminal of a user.

5. The content processing apparatus of claim 1, further comprising:
a physical object order processing section for receiving an order placed by a user for a physical object corresponding to the three-dimensional scene information, and converting the three-dimensional scene information to obtain mesh data for use in executing the order for the physical object.

6. The content processing apparatus of claim 1, further comprising:
a trophy presentation image generating section for generating an image corresponding to a selection of one of a region and an object to be made into the trophy from the displayed scene at the timing for presenting the trophy, and presenting the image as generated to a user, wherein:
prior to performing the machine learning, the three-dimensional scene information generating section extracts an extracted image of the one of the region and the object selected by the user for use in the machine learning.

7. The content processing apparatus of claim 1, wherein the three-dimensional scene information generating section uses, in the machine learning, a region extracted from images for use in the machine learning in accordance with a predetermined criterion.

8. The content processing apparatus of claim 2, wherein the main image generating section generates images for use in the machine learning at a rate higher than the predetermined rate for a frame of a display image.

9. The content processing apparatus of claim 2, further comprising:
an image data transmitting section for consecutively outputting, from among the frames of the main image generated corresponding to the added viewpoints, the frames corresponding to a predetermined sequence of viewpoints as a display image.

10. The content processing apparatus of claim 1, wherein the three-dimensional scene information generating section generates a neural network based on neural radiance fields as the three-dimensional scene information.

11. A content processing method comprising:
generating, at a predetermined rate, a frame of a main image including a three-dimensional display world from a display viewpoint, the three-dimensional display world being changed in status in response to a user operation on currently executed content;
determining, as a timing for presenting a trophy, a time at which the status of the three-dimensional display world has met a predetermined condition as a result of the user operation;
assuming, as the trophy, at least a portion of a displayed scene at the timing for presenting the trophy, before generating three-dimensional scene information through machine learning using, as training data, the main image indicating appearances of the trophy from a plurality of viewpoints; and
storing the three-dimensional scene information, in association with the user operation, in a storage apparatus.

12. One or more non-transitory machine-readable media storing executable instructions that, when executed by one or more processors, cause the one or more processors to at least:
generate, at a predetermined rate, a frame of a main image including a three-dimensional display world from a display viewpoint, the three-dimensional display world being changed in status in response to a user operation on executed content;
determine, as a timing for presenting a trophy, a time at which the status of the three-dimensional display world has met a predetermined condition as a result of the user operation;
assume, as the trophy, at least a portion of a displayed scene at the timing for presenting the trophy, before generating three-dimensional scene information through machine learning using, as training data, the main image indicating appearances of the trophy from a plurality of viewpoints; and
store the three-dimensional scene information, in association with the user operation, in a storage apparatus.
